(19) United States
(12) Patent Application Publication
(10) Pub. No.: US 2007/0152356 A1
(43) Pub. Date: Jul. 5, 2007

(54) Humidifier structure

(76) Inventor: Ping Huang, Tainan Hien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/320,883

(22) Filed: Dec. 30, 2005

(51) Int. Cl. B01F 3/04

(52) U.S. Cl. 261/81; 261/DIG. 48

(57) ABSTRACT

A humidifier includes a plastic housing part, a water-level sensing metal tube, a circuit board, an atomizing device, and a cover; the plastic housing part is formed by means of injection molding, and has a water storage room therein; the water-level sensing metal tube is coupled to and concealed in the plastic housing part at the same time as the plastic housing part is formed so that water contained in the water storage room is prevented from contacting the water-level sensing metal tube; the circuit board is connected to a lower end of the water-level sensing metal tube; the atomizing device is positioned in the water storage room of the plastic housing part; the cover is positioned over the top of the plastic housing part, and it has a wind producing device, and a mist outlet.

### BACKGROUND OF THE INVENTION

1. Field of the Invention

The present invention relates to an improvement on humidifier structure, more particularly one, which includes a plastic housing part, and a water-level sensing metal tube coupled to and concealed in the plastic housing part at the same time as the plastic housing part is formed so as not to contact water contained in the humidifier.

2. Brief Description of the Prior Art

Humidifiers will release mist to make the air in a room less dry, thus preventing colds and allergy symptoms.

Common humidifiers include a plastic housing part, a water level sensor, a water atomizer, and a fan. The plastic housing part is formed by means of injection molding, and has a water sink therein. The water level sensor is positioned in the water sink. The water atomizer can be an ultrasonic vibrator, and it is positioned in the water sink for converting water into mist, which will be sent into the air by means of the fan.

Referring to FIG. 1, a currently existing humidifier is equipped with a float ball 2 and a reed switch (or hall switch) for detecting water level in a water sink therein. The humidifier is relatively large in size, and very difficult to carry because of existence of the float ball 2. Referring to FIG. 2, a probe type sensor switch 3 is fitted in a water sink inside a humidifier instead of a float ball and reed switch combination so as to make the humidifier small-sized. However, when the probe type sensor switch 3 is functioning, water will be electrolyzed in the water sink, and in turn unwanted substance is produced, which will cause damage to the ultrasonic vibrator.

To overcome the above problem, a capacitor type sensor switch is fitted in a humidifier instead of a probe type sensor switch. The capacitor type sensor switch includes a water level sensing metal tube passed through a hole in the water sink, and a heat shrink rubber sleeve positioned around the water level sensing metal tube. Further, waterproof glue is applied between the heat shrink sleeve and the hole in the water sink to help prevent water from contacting the water level sensing metal tube, thus avoiding electricity leakage and damage. However, the heat shrink rubber sleeve will be hit by ultrasonic waves, and corrode and oxidize after having been used for a long length of time. Consequently, water leakage will happen. Furthermore, the complexness of the manufacturing process is increased because waterproof glue has to be applied between the heat shrink sleeve and the hole in the water sink after the heat shrink sleeve is positioned around the water level sensing metal tube.

### SUMMARY OF THE INVENTION

It is a main object of the invention to provide an improvement on a humidifier to overcome the above-mentioned problems. The humidifier of the present invention includes a plastic housing part, a water-level sensing metal tube, a circuit board, an atomizing device, and a cover. The plastic housing part is formed by means of injection molding, and has a water storage room therein. The water-level sensing metal tube is coupled to the plastic housing part and concealed in a holding space at the same time as the plastic housing part is formed. The circuit board is connected to the lower end of the water-level sensing metal tube while the atomizing device is positioned in the water storage room. The cover is positioned over the top of the plastic housing part, and it has a wind producing device, and a mist outlet. Because the water-level sensing metal tube is concealed in the holding space inside the plastic housing part, water contained in the water storage room is prevented from contacting the water-level sensing metal tube.

### BRIEF DESCRIPTION OF THE DRAWINGS

The present invention will be better understood by referring to the accompanying drawings, wherein:

FIG. 1 is an exploded perspective view of the first currently existing humidifier with a float ball and a reed switch,

FIG. 2 is a perspective view of the second currently existing humidifier with a probe type switch,

FIG. 3 is a perspective view of the humidifier in the present invention,

FIG. 4 is an exploded perspective view of the present invention (1),

FIG. 5 is an exploded perspective view of the present invention (2),

FIG. 6 is a top view of the present invention,

FIG. 7 is a sectional view of the present invention (1), and

FIG. 8 is a sectional view of the present invention (2).

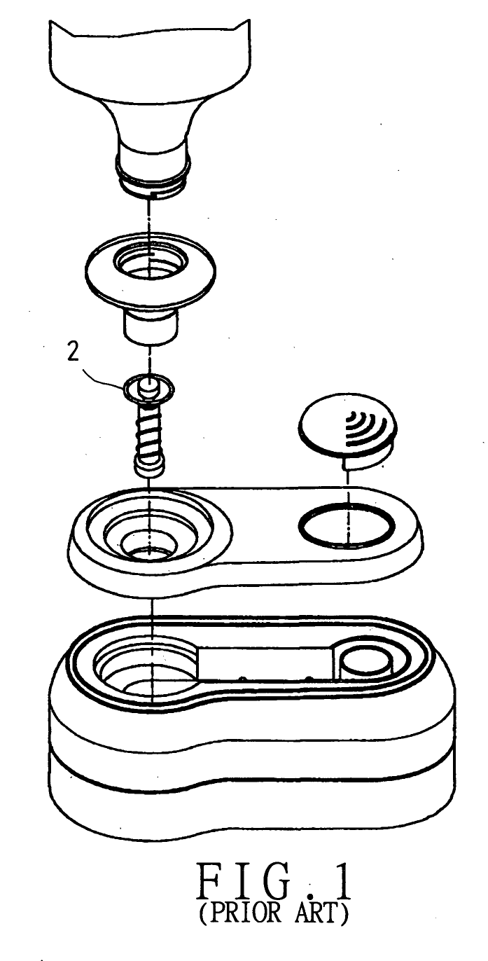

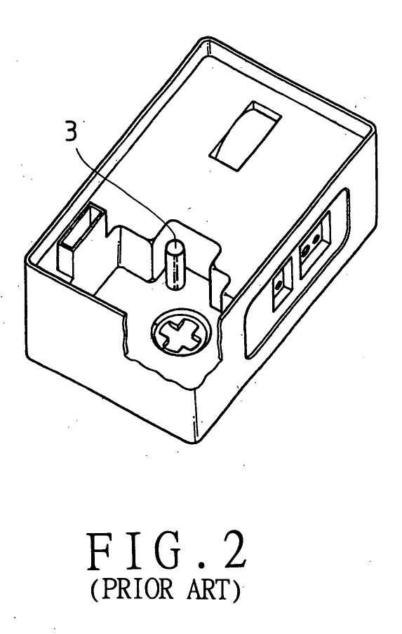

### DETAILED DESCRIPTION OF THE PREFERRED EMBODIMENTS

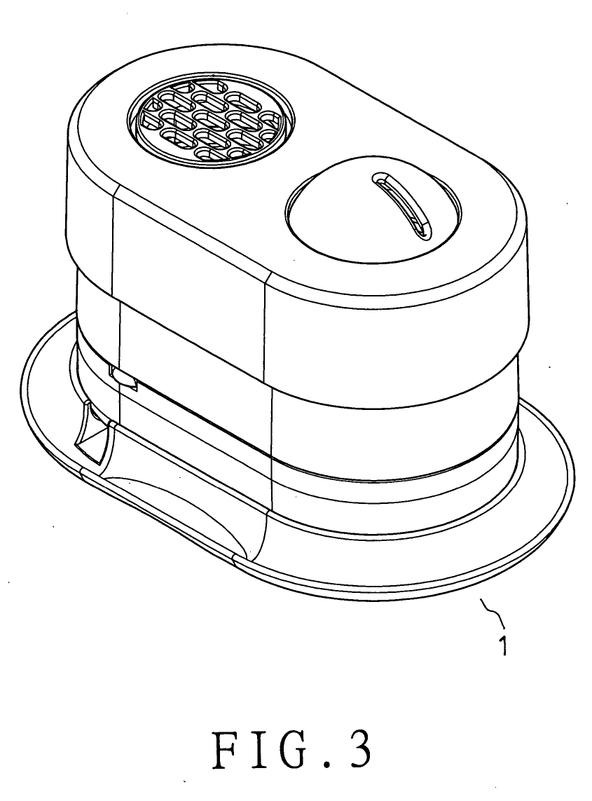

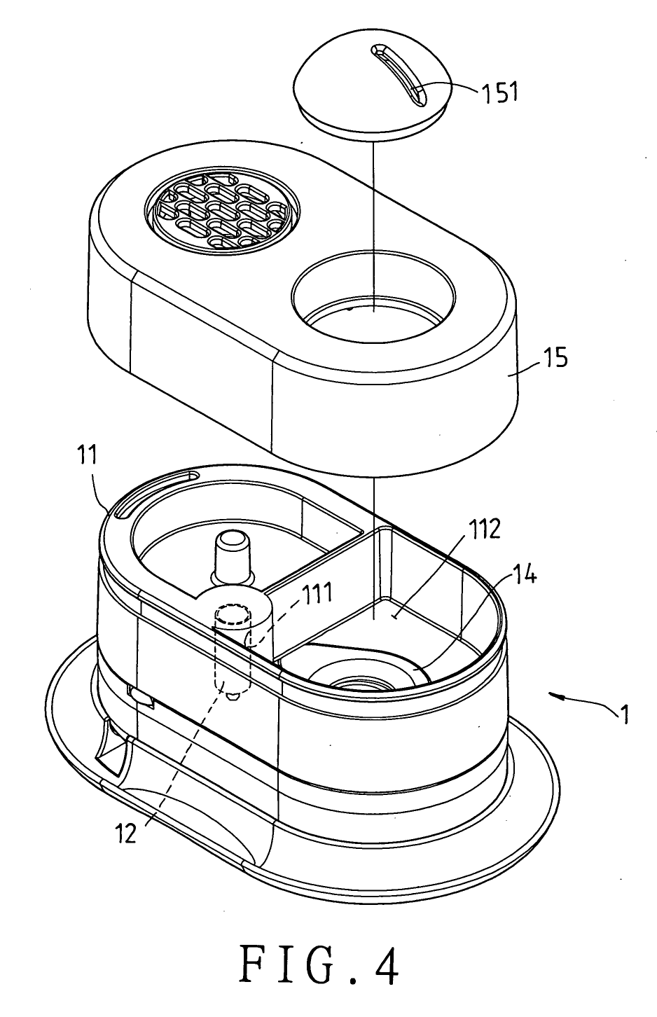

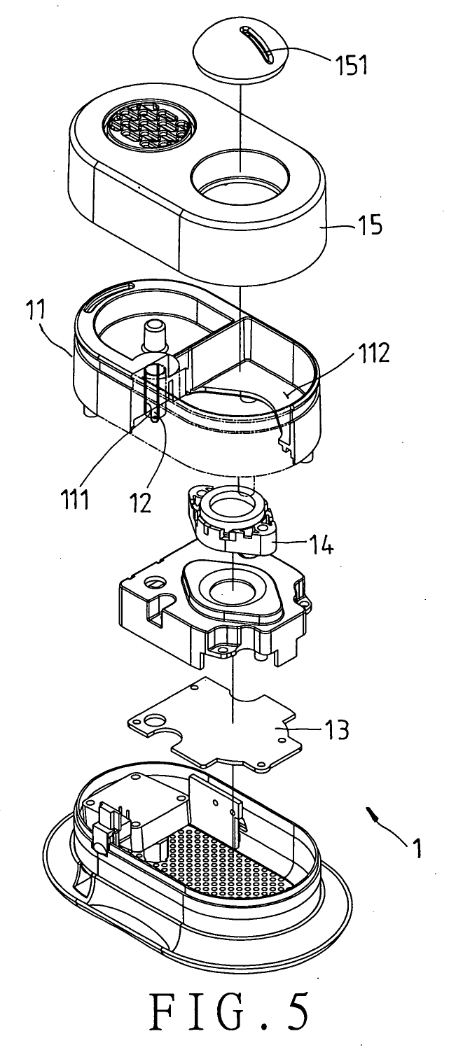

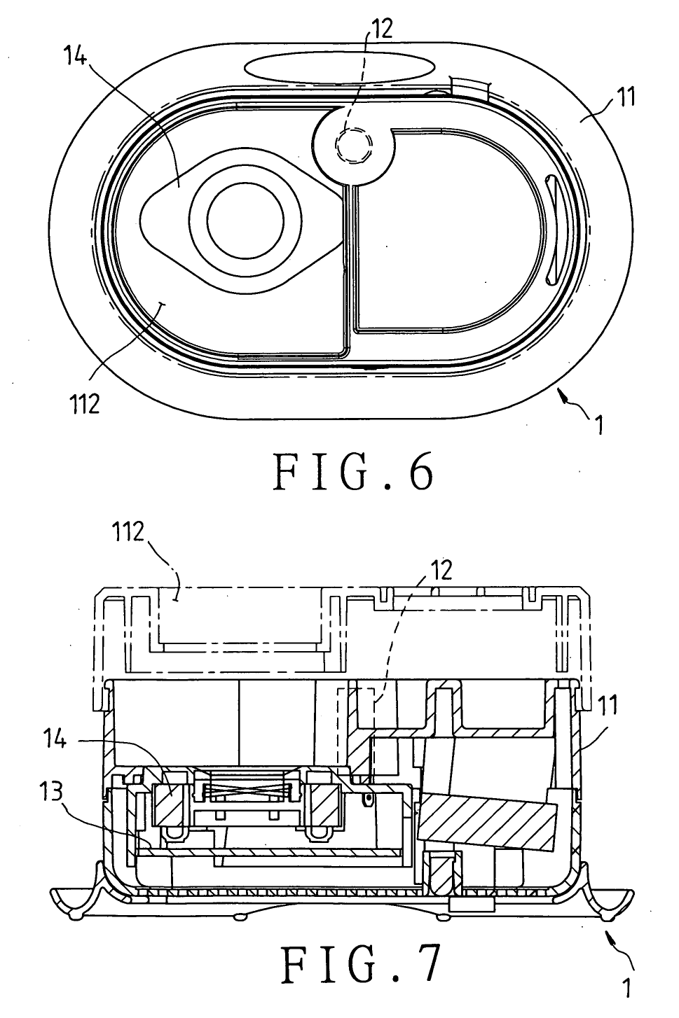

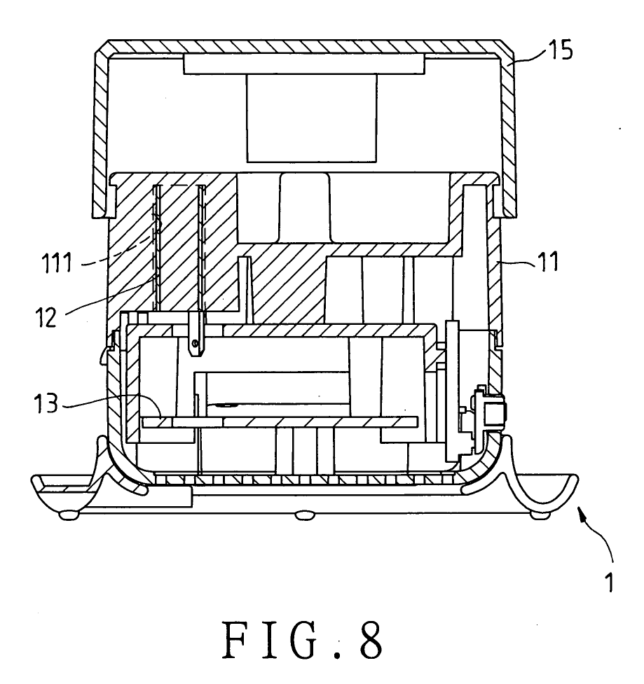

Referring to FIGS. 3 to 8, a preferred embodiment of a humidifier 1 in the present invention includes a plastic housing part 11, a water-level sensing metal tube 12, a circuit board 13, an atomizing device 14, and a cover 15.

The plastic housing part 11 is made by means of injection molding, which is carried out after the water level sensing metal tube 12 has been positioned in the mold of the plastic housing part 11; thus, the water-level sensing metal tube 12 will be concealed in a holding space 111 and coupled to the plastic housing part 11 at the same time as the plastic housing part 11 is formed. The plastic housing part 11 further has a water storage room 112 next to the holding space 111.

The circuit board 13 is connected to a lower end of the water-level sensing metal tube 12 for detecting the change in capacitance and inductance of the water-level sensing metal tube 12.

The atomizing device 14 can be an ultrasonic vibrator, and it is positioned in the water storage room 112 of the plastic housing part 11, and connected to the circuit board 13.

The cover 15 has a wind producing device, and a mist outlet 151, and it is positioned over the top of the plastic housing part 11.

Therefore, when the humidifier 1 is activated, and water injected into the water storage room 112 of the plastic housing part 11, the atomizing device 14 will vibrate and atomize water contained in the water storage room 112 into mist, which will immediately escape into the air through the mist outlet 151 of the cover 15. At the same time, the change in water level in the water storage room 112 is detected and measured by means of detecting the capacitance and inductance of the water-level sensing metal tube 12; the atomizing device 14 will be automatically turned off if the amount of water left in the water storage room 112 isn't enough, preventing damage of the atomizing device 14 and danger. Furthermore, because the water-level sensing metal tube 12 is concealed in the holding space 111 of the housing part 11, water contained in the water storage room 112 is prevented from contacting the water-level sensing metal tube 12, thus ensuring that the humidifier 1 will function stably.

From the above description, it can be easily seen that the humidifier of the present invention has the following advantages:

1. Because before the injection molding process for the plastic housing part is carried out, the water-level sensing metal tube is positioned in the mold, the water-level sensing metal tube will be concealed in the holding space of the housing part, and prevented from contacting water at the same time as the plastic housing part is formed, eliminating the need to use a heat shrink sleeve around the water-level sensing metal tube. Therefore, the present invention overcomes the disadvantage of the prior art equipped with the heat shrink sleeve, which will corrode and break after used for a long length of time.

2. Because the water-level sensing metal tube is concealed in the holding space of the plastic housing part, and prevented from contacting water at the same time as the plastic housing part is formed, there is no need to use a thermoplastic sleeve around the water-level sensing metal tube or apply water-proof glue on a heat shrink sleeve. Therefore, the humidifier has a simpler manufacturing process, and the manufacturing cost will reduce.

What is claimed is:

1. An improvement on humidifier structure, comprising
a plastic housing part; the plastic housing part having a water storage room therein;
a water-level sensing metal tube concealed in the plastic housing part; the water level sensing metal tube being positioned, before an injection molding process, in a mold of the plastic housing part such that the water-level sensing metal tube is coupled to the plastic housing part at a same time as the plastic housing part is formed;
a circuit board connected to the water-level sensing metal tube;
an atomizing device positioned in the water storage room of the plastic housing part; and
a cover positioned over a top of the plastic housing part; the cover having a wind producing device, and a mist outlet.

2. The improvement on humidifier structure as claimed in claim 1, wherein the atomizing device is an ultrasonic vibrator.
